(19) United States
(12) Patent Application Publication
(10) Pub. No.: US 2008/0217795 A1
(43) Pub. Date: Sep. 11, 2008

(54) HUMIDIFIER DEVICE FOR FUEL CELL

(76) Inventors: Alexander Gofer, Pompano Beach, FL (US); Konstantin Korytnikov, Hollywood, FL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 12/044,659

(22) Filed: Mar. 7, 2008

Related U.S. Application Data
(60) Provisional application No. 60/893,482, filed on Mar. 7, 2007.

(51) Int. Cl. B01F 3/04

(52) U.S. Cl. 261/104

(57) ABSTRACT

A device of the present invention transfers the moisture and heat from an exhaust delivered from a fuel cell cathode to the air introduced to a fuel cell as a cathode reactant. The device includes at least one moisture exchange unit having reactant compartment, an exhaust compartment, and a polymer member permeable for water vapor separating these compartments. A reactant inlet manifold and a reactant outlet manifold of the device are in fluid communication through the reactant compartment of the moisture exchange unit. An exhaust inlet manifold and an exhaust outlet manifold of the device are also in fluid communication with the exhaust compartment the moisture exchange unit.

### RELATED APPLICATIONS

This non-provisional application claims priority to a provisional application Ser. Nos. 60/893,482 filed on Mar. 7, 2007 and incorporated by reference herein in its entirety.

### FIELD OF THE INVENTION

The present invention relates to an electrochemical energy conversion device, such as fuel cells, that produce electrical power, and more particularly the present invention related to a humidifier for a fuel cell assembly.

### BACKGROUND OF THE INVENTION

Hydrogen fuel cells convert the chemical energy stored in hydrogen and oxygen into electricity, heat, and water. One of the benefits of the fuel cell over, for example, a battery, is the ability of the fuel cell to operate virtually continuously as long as necessary flows are maintained. Unlike the battery, which store electrical energy chemically in a closed system, the fuel cells consume reactants, which must be replenished. Additionally, while the electrodes within the battery react and change as a battery is charged or discharged, the electrodes of the fuel cell are catalytic and relatively stable.

Fuel cells employ an electrolyte disposed between two electrodes, such as a cathode and an anode. The electrodes generally comprise a porous, electrically conductive gas diffusion layer (GDL) material and an electrocatalyst disposed at the interface between the electrolyte and the electrode layers. The electrocatalyst enhances the electrochemical reactions: hydrogen oxidation and oxygen reduction reactions. Polymer electrolyte membrane (PEM) fuel cells, also called the solid polymer fuel cells, typically employ a membrane electrode assembly (MEA) consisting of a proton exchange membrane as electrolyte disposed between two electrode layers. The membrane, in addition of being ion-conductive material, also is an electrical insulator and a physical barrier for reactants mix.

The MEA is typically interposed between two electrically conductive plates. The plates act as current collectors, and provide also mechanical support to the MEA. The current collector plates may have channels, or openings in one or both plate surfaces to direct the fuel and oxidant to the respective electrode layers, namely the anode on the fuel side and the cathode on the oxidant side.

Typically fuel cells are assembled together in series into fuel cell stacks to increase the overall output power. In series arrangement, one side of a plate may serve as cathode plate for the adjacent cell, with the current collector plate functioning as a bipolar plate with the other side functioning as the anode. Such a bipolar plate may have flow field channels formed on both active surfaces. The fuel cell stack includes an inlet port and manifold for directing a coolant fluid to interior passages within the stack to absorb heat generated by the electrochemical reaction in the fuel cells. The stack also includes exhaust manifolds and outlet ports for expelling the non reacted fuel and oxidant, and water generated in the reaction. It may also have an exhaust manifold and outlet port for the coolant stream exiting the stack. The stack manifolds may be internal created through aligned openings formed in the separator layers and the MEAs, or may have external or edge manifolds, attached to the edges of the separator layers.

The fuel cell stacks are compressed to enhance sealing and electrical contact between the surfaces of the plates and the MEAs, and between adjoining plates. In conventional fuel cell stacks, the fuel cell plates and MEAs are typically compressed and maintained in their assembled state between a pair of end plates by tie rods or tension members. The tie rods typically extend internally or externally to the stack through holes formed in the stack end plates, and have associated nuts or other fastening means to secure them in the stack assembly.

An electrochemical reaction between hydrogen and the oxygen contained in the air produces the electrical current, water and heat as the reaction products. Water is removed from the cathode to make the catalytic layer accessible for the oxygen. On the other hand, the air introduced to the cathode supposed to be rich in water vapor to prevent drying out of the PEM, which results in failure of the fuel cell failure. In some fuel cell systems the hydrogen, delivered to the anode, is also subject for humidification. A humidifier of the fuel cell presents the main device to keep the correct water balance in the fuel cell, thereby transferring the moisture across an internal membrane permeable for water molecules from water carrier to gas introduced into the fuel cell as the reactant. The major sources of water intended for the humidification are DI water or an exhaust gas from the fuel cell cathode.

A fuel cell humidifier is one of the important components to keep the correct water balance in the fuel cell. The major operational principle of the fuel cell humidifier is to transfer the moisture (across membrane permeable for water molecules) from the cathode exhaust leaving the cathode to the air introduced in the cathode of the fuel cell stack as the reactant. The most important humidifier performance characteristic is the approach temperature—the difference in the dew point temperature of the cathode exhaust and the reactant. The applicable approach temperature is 3-9° C. However, if the temperature exceeds this range, the fuel cell's lifespan and performance will be negatively impacted.

The optimal value of the approach temperature in a given interval depends mainly on the operational conditions of the fuel cell stack (the reactant pressure, the air stoichiometric ratio, the fuel cell temperature). Like any power generating plant with a low efficiency, the fuel cell system incorporates the components responsible for heat withdrawal, which consume sufficient amount of power produced by the system. In case of a manned automotive application another 1-3 kW is spent to drive a conditioner.

The overall current size and the cost of a modern fuel cell system makes it unpracticable and will increase the overall cost of the modern fuel cell is an air conditioning unit is added to the modern fuel cell as an integral part. Thus, there is a constant need in the area of the fuel cell art for an improved design of a fuel cell humidifier having an effective and low-cost humidifier installed therein.

### SUMMARY OF THE INVENTION

A humidifier device (the humidifier) of the present invention is used with a fuel cell for balancing fluids therein. The humidifier of the present invention transfers the moisture and heat to the air introduced the fuel cell as the cathode reactant. Simultaneously the device may produce cooling media and serves as cooling apparatus. The humidifier includes at least one moisture exchange cartridge separated into the reactant and exhaust compartments with a polymer membrane. The flow introduced to the exhaust compartment is an exhaust from the cathode at the dew point temperature close or even to the temperature of the fuel cell operation. The air, as a reactant, distributed into the reactant compartment is relatively dry. It is directed by either a blower or a compressor. In first case the reactant temperature is close to ambient, in another one it is supposed to be elevated.

A polymer membrane used in the humidifier is permeable for water vapor. Mechanism of the water movement across the polymer membrane depends on its type. For the PEM, known as “Nafion”, the water transport associates with chemical reactivity between water molecules and sulfonic acid groups imbedded. In case of the membrane with micro-porous structure water is accommodated in pores on one side of a membrane and, then, realized in a gas stream from the other site. In both cases the water transport through the membrane is driven mainly by partial vapor pressure differential. The humidifier provides the water transport across the membrane from the exhaust saturated with water vapor to the reactant having lower water vapor pressure. This process is accompanied with the heat flow in the same direction. As result, on one hand, the exhaust temperature drops while the gas travels along the moisture exchange cartridge; on other hand, the partial pressure of water vapor and the temperature of the reactant flowing through the reactant compartment rise. The flows have to be directed in the countercurrent way to maintain the efficient gradient of heat and water vapor along the moisture exchange cartridge length.

The humidifier design assumes that the membrane package, the configuration of compartments and the flow direction allow each portion of the introduced gases to be in contact with the membrane to order to be involved in the process of the heat and moisture exchange. From such point of view the most effective membrane package is plurality of hollow tubes arranged in a bundle (cylindrical or rectangular) which is inserted into a shell of the moisture exchange cartridge. The exhaust stream is directed, preferably, into the fiber tubes, the reactant flow passes the shell space over the external side of the tubes. At an inlet of the exhaust compartment of the cartridge (cartridges) there is an adjustable (manually or automatically) valve to divert an exhaust portion from entering in the moisture exchange cartridge which allowing the control of the amount of heat and water vapor introduced into the cartridge, and, as result, the maintenance of an optimal value of the approach temperature. The decrease in a volumetric proportion between the exhaust and the reactant participating in the moisture exchange in the cartridge (exhaust/reactant ratio) results in higher approach temperature (lower reactant vapor pressure).

In prior art, according to U.S. Pat. No. 6,471,195, a desired dew point temperature of the humidified air is maintained by changing the number of water permeable device by a plurality of butterfly valves. In case, how it is shown in second embodiment, if the exhaust/reactant ratio is less than 0.7 there is a sufficient drop in the temperature of the exhaust leaving the moisture exchange cartridge due to the elevated heat loss to a value below the ambient temperature so that the given exhaust stream can serve as a coolant media. The way to maintain the exhaust/reactant ratio at value less than 0.7 is to prevent at least 30% of the exhaust from entering in the moisture exchange cartridge (cartridges) by means of the adjustable valve partially open. Other part of the exhaust, after passing the hollow tubes, is supposed to possess the cooling ability.

Third embodiment of the invention assumes that in the humidifier at least two moisture exchange cartridges or a cartridge cascades (each cascade comprises, at least, two cascades connected in parallel regarding both to the reactant and the exhaust) is connected in parallel regarding to the reactant and in series regarding to the exhaust. Under the given connection the exhaust/reactant ratio is equal to 1/n (“n” is a number of the moisture exchange cartridges or the cartridge cascades in series regarding to the reactant). The desired reactant vapor pressure builds up gradually, in sequence of the moisture exchange cartridges or the cartridge cascades. Even at very low fuel cell air demand the reactant flow through any moisture exchange cartridge remains relatively high to be forced into the fiber bundle core to keep the moisture exchange at the proper level. In third embodiment the exhaust/reactant ratio is, at least, 0.5 (n=2). The exhaust passing, at least, the first moisture exchange cartridge (or cartridge cascade) regarding the reactant flow is supposed to be used for cooling purposes. The humidifier contains a water discharger to withdraw the liquid water (mainly, as product of condensation) from the reactant delivered to the fuel cell. The water discharger has two chambers separated with a membrane selectively permeable for water. First chamber is in fluid communication with a reactant outlet manifold of the humidifier and second one is open to an exhaust outlet manifold. If the reactant pressure exceeds the exhaust pressure, which is generally true, the discharger is able to drain the water from the outlet manifold of the reactant compartment preventing fuel cells against flooding.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a cross sectional view of a humidifier of the present invention;

FIG. 2 is a cross sectional view of the humidifier of a second embodiment of the invention;

FIG. 3 is a perspective view of the humidifier of the second embodiment of the invention; and

FIG. 4 is the cross sectional view of the humidifier of a third embodiment of the invention.

### DETAILED DESCRIPTION OF THE PREFERRED EMBODIMENT

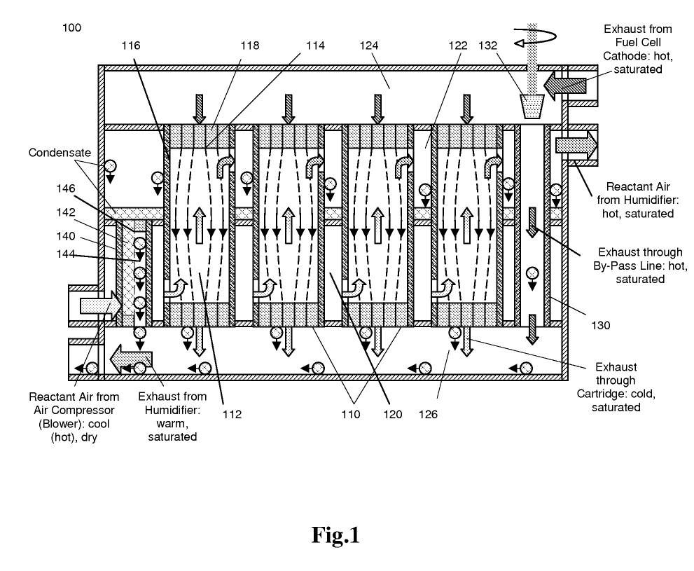

Referring to the Figures, wherein like numerals indicate like or corresponding parts, a humidifier is shown in FIG. 1 and generally designated by the reference numeral 100 incorporates four moisture exchange units 110. Each moisture exchange unit 110 designed as a bundle of polymer membrane hollow tubes 114 inserted into a shell 116 so that a space 118 between the polymer membrane hollow tubes themselves and between the hollow tubes and the shell 116 is filled with sealing media, preferably with an epoxy resin, on both ends of the moisture exchange unit 110.

An reactant inlet manifold 120 and a reactant outlet manifold 122 of humidifier 100 are in flow communication through a space 112 restricted with the bundle of polymer membrane hollow tubes 114 and the shell 116 of moisture exchange units 110. An exhaust inlet manifold 124 and an exhaust outlet manifold 126 of humidifier 100 are in flow communication through internal capillaries of membrane hollow tubes of the bundle 114, and through a by-pass line 130 which is secured with an adjustable valve 132. The humidifier 100 incorporates a water discharger 140 comprising: a water collecting chamber 142; a water disposing chamber 144; a polymer water discharger membrane 146 permeable for water vapor separating the chambers 142 and 144. The reactant outlet manifold 122 of humidifier 100 is in flow communication with the water collecting chamber 142 of the water discharger 140; the exhaust outlet manifold 126 of the humidifier 110 is in flow communication with a water disposing chamber 144 of the water discharger 140.

In humidification process utilizing the humidifier 100 a fuel cell cathode exhaust is distributed to the exhaust inlet manifold 124 and a reactant air is introduced by an air compressor (an air blower) to the reactant inlet manifold 120. Part of the fuel cell cathode exhaust can be released by means of adjustable valve 132 from the exhaust inlet manifold 124 to the exhaust outlet manifold 126 through the by-pass line 130 without participation in the moisture and heat exchange. Other part of the fuel cell cathode exhaust flows to the exhaust outlet manifold 126 by internal capillaries of the polymer membrane hollow tubes combined in the bundles 114 of the moisture exchange units 110. The reactant air moves from the reactant inlet manifold 120 to the reactant outlet manifold 122 of the humidifier 100 through the space 112 inside the moisture exchange units 110. Along the moisture exchange units 110 water and heat are transferred from the fuel cell cathode exhaust to the reactant air.

The adjustable valve 132 controls the amount of heat and water vapor introduced into the moisture exchange units 110, and, as result, is means to maintain an optimal value of the approach temperature (the reactant vapor pressure) for the specific fuel cell operational condition. Water condensate derived from the reactant air is collected on the bottom of the reactant outlet manifold 120 due to the gravity, then, transported through the water collecting chamber 142 of the water discharger 140 to the water disposing chamber 144 through the water-permeable polymer water discharger membrane 146 under the pressure difference which equals, in general, a sum of the pressure drops for the reactant air across the fuel cell and for the fuel cell cathode exhaust along the moisture exchange units 110 of the humidifier 100.

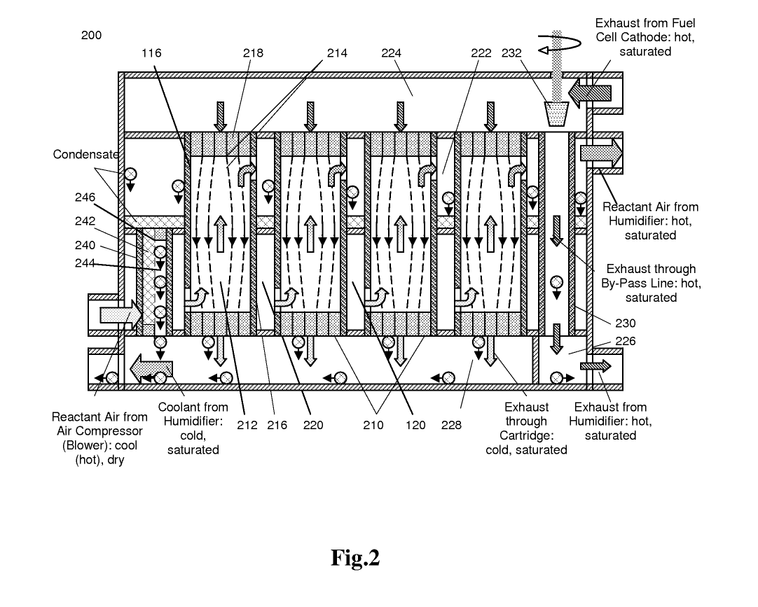

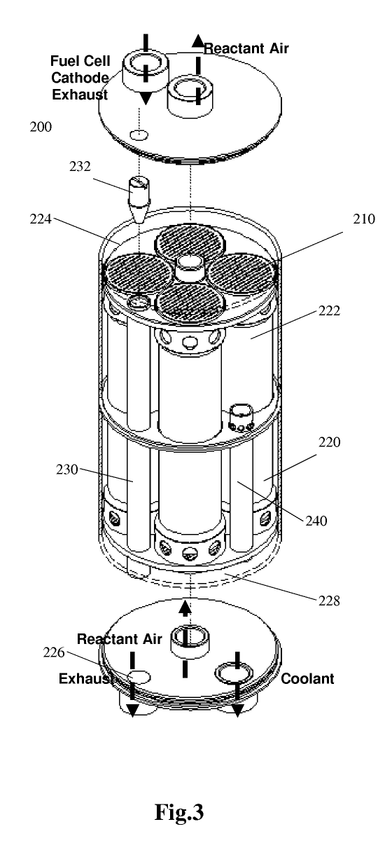

In second embodiment referring to the drawing, the humidifier shown in FIGS. 2 and 3 and generally designated by the reference numeral 200 incorporates four moisture exchange units 210. Each moisture exchange unit 210 designed as a bundle of polymer membrane hollow tubes 214 inserted into a shell 216 so that a space 218 between the polymer membrane hollow tubes themselves and between the hollow tubes and the shell 216 is filled with sealing media, preferably with an epoxy resin, on both ends of the moisture exchange unit 210.

An reactant inlet manifold 220 and a reactant outlet manifold 222 of humidifier 200 are in flow communication through a space 212 restricted with the bundle of polymer membrane hollow tubes 214 and the shell 216 of moisture exchange units 210. An exhaust inlet manifold 224 is in flow communication with a coolant outlet manifold 228 of humidifier 200 through internal capillaries of membrane hollow tubes of the bundle 214, and with the exhaust outlet manifold 226 of humidifier 200 through a by-pass line 230 which is secured with an adjustable valve 232. The humidifier 200 incorporates a water discharger 240 comprising: a water collecting chamber 242; a water disposing chamber 244; a polymer water discharger membrane 246 permeable for water vapor separating the chambers 242 and 244.

The reactant outlet manifold 222 of humidifier 200 is in flow communication with the water collecting chamber 242 of the water discharger 240; the exhaust outlet manifold 226 of the humidifier 200 is in flow communication with a water disposing chamber 244 of the water discharger 240. In humidification process utilizing the humidifier 200 a fuel cell cathode exhaust is distributed to the exhaust inlet manifold 224 and a reactant air is introduced by an air compressor (an air blower) to the reactant inlet manifold 220. Part of the fuel cell cathode exhaust can be released by means of adjustable valve 232 from the exhaust inlet manifold 224 to the exhaust outlet manifold 226 of the humidifier 200 through the by-pass line 230 without participation in the moisture and heat exchange. Other part of the fuel cell cathode exhaust flows to the coolant outlet manifold 228 by internal capillaries of the polymer membrane hollow tubes combined in the bundles 214 of the moisture exchange units 210. The reactant air moves from the reactant inlet manifold 220 to the reactant outlet manifold 222 of the humidifier 200 through the space 212 inside the moisture exchange units 210. Along the moisture exchange units 210 water and heat are transferred from the fuel cell cathode exhaust to the reactant air. The adjustable valve 232 controls the amount of heat and water vapor introduced into the moisture exchange units 210, and, as result, is means to maintain an optimal value of the approach temperature (the reactant vapor pressure) for the specific fuel cell operational condition.

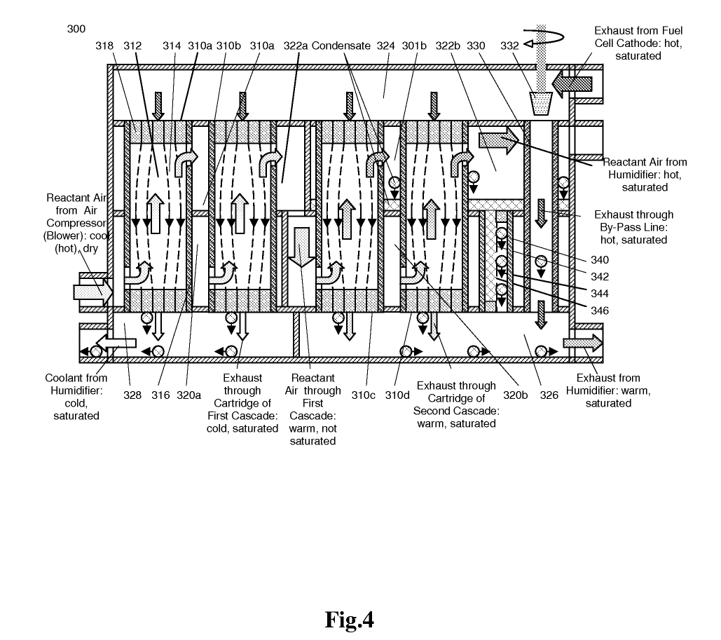

In case if the portion of the fuel cell cathode exhaust directed into the moisture exchange units 210 by adjustment adjustable valve 232 is less than 70% of the total fuel cell exhaust the flow from the coolant outlet manifold 228 can be distributed then as the coolant due to the elevated heat loss to a value below the ambient temperature occurred in the fuel cell cathode exhaust flowing along the moisture exchange units 210. Water condensate derived from the reactant air is collected on the bottom of the reactant outlet manifold 220 due to the gravity, then, transported through the water collecting chamber 242 of the water discharger 240 to the water disposing chamber 244 through the water-permeable polymer water discharger membrane 246 under the pressure difference which equals, in general, a sum of the pressure drops for the reactant air across the fuel cell and for the fuel cell cathode exhaust along the moisture exchange units 210 of the humidifier 200. In third embodiment referring to the drawing, the humidifier shown in FIG. 4 and generally designated by the reference numeral 300 incorporates four moisture exchange units 310.

Each moisture exchange unit 310 designed as a bundle of polymer membrane hollow tubes 314 inserted into a shell 316 so that a space 318 between the polymer membrane hollow tubes themselves and between the hollow tubes and the shell 316 is filled with sealing media, preferably with an epoxy resin, on both ends of the moisture exchange unit 310. The humidifier 300 combines two cascades 301a, 301b connected regarding to the reactant air in series and in parallel regarding to the fuel cell cathode exhaust. The cascades 301a and 301b combine, consequently, the moisture exchange units 310a,b and 310c,d. The moisture exchange units of each cascade are connected in parallel regarding to both the reactant air the fuel cell cathode exhaust.

A reactant inlet manifold 320a (320b) of the cascade 301a (320b) is in fluid communication with a reactant outlet manifold 322a (322b) of cascade 301a (301b) through a space 312 restricted with the bundle of polymer membrane hollow tubes 314 and the shell 316 of moisture exchange units 310a,b (310c,d).

An exhaust inlet manifold 324 of humidifier 300 is in flow communication: with an coolant outlet manifold 328 of humidifier 300 through the moisture exchange units 310a,b of cascade 301a; with an exhaust outlet manifold 326 of humidifier 300 through the moisture exchange units 310c,d of cascade 301b and through a by-pass line 330 which is secured with an adjustable valve 332. The humidifier 300 incorporates a water discharger 340 comprising: a water collecting chamber 342; a water disposing chamber 344; a polymer water discharger membrane 346 permeable for water vapor separating the chambers 342 and 344. The reactant outlet manifold 322b of cascade 301b is in flow communication with the water collecting chamber 342 of the water discharger 340; the exhaust outlet manifold 326 of the humidifier 300 is in flow communication with a water disposing chamber 344 of the water discharger 340.

In humidification process utilizing the humidifier 300 a fuel cell cathode exhaust is distributed to the exhaust inlet manifold 324 of the humidifier 300 and a reactant air is introduced by an air compressor (an air blower) to the reactant inlet manifold 320 of the cascade 301a. Part of the fuel cell cathode exhaust can be released by means of adjustable valve 332 from the exhaust inlet manifold 324 to the exhaust outlet manifold 226 of the humidifier 300 through the by-pass line 330 without participation in the moisture and heat exchange. Other part of the fuel cell cathode exhaust flows along the moisture exchange units 310 by internal capillaries of the polymer membrane hollow tubes combined in the bundles 314. The reactant air moves from the reactant inlet manifold 320a of the cascade 301a to the reactant outlet manifold 322a along the moisture exchange units 310a,b, and, then from the reactant inlet manifold 320b of the cascade 301b to the reactant outlet manifold 322b along the moisture exchange units 310c,d. Along the moisture exchange units 310 water and heat are transferred from the fuel cell cathode exhaust to the reactant air.

The adjustable valve 332 controls the amount of heat and water vapor introduced into the moisture exchange units 310, and, as result, is means to maintain an optimal value of the approach temperature (the reactant vapor pressure) for the specific fuel cell operational condition. As of the fuel cell cathode exhaust directed into the moisture exchange units 310a,b is twice less of the total fuel cell exhaust flowing through the moisture exchange units 310a,b the flow from the coolant outlet manifold 328 of the cascade 301a can be distributed then as the coolant due to the elevated heat loss to a value below the ambient temperature occurred in the fuel cell cathode exhaust flowing along the moisture exchange units 310a,b.

Water condensate occurring in the reactant outlet manifold 322b of the cascade 302a from the reactant air is collected on the bottom of the reactant outlet manifold 322b due to the gravity, then, transported through the water collecting chamber 342 of the water discharger 340 to the water disposing chamber 344 through the water-permeable polymer water discharger membrane 346 under the pressure difference which equals, in general, a sum of the pressure drops for the reactant air across the fuel cell and for the fuel cell cathode exhaust along the moisture exchange units 310c,d of the cascade 302a.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A device transferring the moisture and heat from an exhaust delivered from a fuel cell cathode to the air introduced to a fuel cell as a cathode reactant comprising:
at least one moisture exchange unit having reactant compartment;
at least one exhaust compartment; and
a polymer membrane permeable for water vapor separating said compartments.

2. The device according with claim 1, wherein a reactant inlet manifold and a reactant outlet manifold of said device are in fluid communication through said reactant compartment of said moisture exchange unit (units); an exhaust inlet manifold and an exhaust outlet manifold of the device are in fluid communication through said exhaust compartment said moisture exchange unit (units) and through a by-passing line secured with a flow controlling means.

3. The device according with claim 2, wherein the cathode exhaust flow through said by-passing line is controlled by adjustment of said flow controlling means in order to maintain a desirable moisture contents in the cathode reactant at said reactant outlet manifold of the device.

4. The device according with claim 1, containing a water discharger comprising: a water collecting chamber; a water disposing chamber; a water permeable polymer membrane separating said chambers.

5. The device according with claim 4, wherein said water collecting chamber of said water discharger is in fluid communication with a bottom of said reactant outlet manifold of the device and said water disposing chamber of said water discharger is in fluid communication with said exhaust outlet manifold of the device so that the water condensate collected on the bottom of said reactant outlet manifold of the device is moved through said water permeable polymer membrane of said water discharger to said exhaust outlet manifold of the device said exhaust outlet manifold of the device under the pressure difference.

6. The device according with claim 1, wherein a reactant inlet manifold and a reactant outlet manifold of said device are in fluid communication through said reactant compartment of said moisture exchange unit (units); an exhaust inlet manifold and a coolant outlet manifold of the device are in fluid communication through said exhaust compartment of said moisture exchange unit (units); said exhaust inlet and an exhaust outlet of the device are in fluid communication through a by-passing line secured with a flow controlling means.

7. The device according with claim 6, wherein the portion of the cathode exhaust flow directed into said exhaust compartment of said moisture exchange unit (units) by adjustment of said flow controlling means is less than 70% of the total exhaust flow delivered from the fuel cell cathode to the device in order to be distributed then as the coolant from said coolant outlet manifold of the device.

8. The device according with claim 6, containing a water discharger comprising: a water collecting chamber; a water disposing chamber; a water permeable polymer membrane separating said chambers.

9. The device according with claim 8, wherein said water collecting chamber of said water discharger is in fluid communication with a bottom of said reactant outlet manifold of the device and said water disposing chamber of said water discharger is in fluid communication with said exhaust outlet manifold of the device so that the water condensate collected on the bottom of said reactant outlet manifold of the device is moved through said water permeable polymer membrane of said water discharger to said exhaust outlet manifold of the device said exhaust outlet manifold of the device under the pressure difference.

10. The device according with claim 8, wherein said water collecting chamber of said water discharger is in fluid communication with a bottom of said reactant outlet manifold of the device and said water disposing chamber of said water discharger is in fluid communication with said coolant outlet manifold of the device so that the water condensate collected on the bottom of said reactant outlet manifold of the device is moved through said water permeable polymer membrane of said water discharger to said coolant outlet manifold of the device said exhaust outlet manifold of the device under the pressure difference.

11. The device according with claim 8, wherein said water collecting chamber of said water discharger is in fluid communication with a bottom of said reactant outlet manifold of the device and said water disposing chamber of said water discharger is in fluid communication with a liquid water outlet of the device so that the water condensate collected on the bottom of said reactant outlet manifold of the device is moved through said water permeable polymer membrane of said water discharger out of the device under the pressure difference.

12. A device transferring the moisture and heat from an exhaust delivered from a fuel cell cathode to the air introduced to a fuel cell as a cathode reactant comprising: at least two, cascades connected in parallel regarding to the reactant and in series regarding to the exhaust.

13. The device according with claim 12, wherein each said cascade consists of, at least, one moisture exchange unit having reactant compartment; exhaust compartment; a polymer membrane permeable for water vapor separating said compartments.

14. The device according with claim 13, wherein said moisture exchange units of each said cascade connected in parallel regarding to the reactant and in parallel regarding to the exhaust.

15. The device according with claim 12, wherein an exhaust inlet manifold of, at least, said first cascade, regarding to the reactant is in fluid communication with a coolant outlet manifold of said device.

16. The device according with claim 12, wherein an exhaust inlet manifold of, at least, said last cascade, regarding to the reactant is in fluid communication with an exhaust outlet manifold of said device.

17. The device according with claim 15, wherein the exhaust from said coolant outlet manifold of, at least, the first said cascade can be distributed then as the coolant.

18. The device according with claim 16, wherein said exhaust inlet manifold and said exhaust outlet manifold accepting the exhaust from, at least, said last cascade regarding the reactant are in fluid communication through a by-passing line secured with a flow controlling means.

19. The device according with claim 12, wherein the cathode exhaust flow through said by-passing line is controlled by adjustment of said flow controlling means in order to maintain a desirable moisture contents in the cathode reactant at said reactant outlet manifold of the device.

20. The device according with claim 12, containing a water discharger comprising: a water collecting chamber; a water disposing chamber; a polymer water discharger membrane permeable for water vapor separating said chambers.

21. The device according with claim 20, wherein said water collecting chamber of said water discharger is in fluid communication with a bottom of said reactant outlet manifold of, at least, of said last cascade, regarding to the reactant and said water disposing chamber of said water discharger is in fluid communication with said exhaust outlet manifold of said device so that the water condensate collected on the bottom of said reactant outlet manifold, at least, of said last cascade, regarding to the reactant is moved through said water permeable polymer membrane of said water discharger to said exhaust outlet manifold of said device under the pressure difference.

22. The device according with claim 20, wherein said water collecting chamber of said water discharger is in fluid communication with a bottom of said reactant outlet manifold of, at least, of said last cascade, regarding to the reactant and said water disposing chamber of said water discharger is in fluid communication with of a liquid water outlet said device so that the water condensate collected on the bottom of said reactant outlet manifold, at least, of said last cascade, regarding to the reactant is moved through said water permeable polymer membrane of said water discharger out of said device under the pressure difference.
